(19) United States
(12) Patent Application Publication
(10) Pub. No.: US 2026/0131275 A1
(43) Pub. Date: May 14, 2026

(54) SYSTEM AND METHOD FOR TARGETED GAS DESORPTION FROM SORBENTS VIA AN EDUCTOR PUMP MECHANISM

(71) Applicant: Mosaic Materials, Inc., Alameda, CA (US)

(72) Inventors: Jared Blanton, Oakland, CA (US); Ignacio Luz, Alameda, CA (US); Nikita Pratap, Mountain View, CA (US)

(21) Appl. No.: 19/382,636

(22) Filed: Nov. 7, 2025

Related U.S. Application Data
(60) Provisional application No. 63/717,944, filed on Nov. 8, 2024.

(51) Int. Cl. B01D 53/04

(52) U.S. Cl. CPC B01D 53/0438; B01D 2251/304; B01D 2251/604; B01D 2252/103; B01D 2253/202; B01D 2253/204; B01D 2257/504; B01D 2259/40092; B01D 2259/40094

(57) ABSTRACT

A system for regenerating a sorbent, including a sealed chamber operative to receive the sorbent; a liquid circuit in fluid communication with the sealed chamber; an eductor pump disposed in the liquid circuit and having a motive-fluid nozzle, a diffuser, and a suction port in fluid communication with the sealed chamber; an entrained-gas separator downstream of the eductor pump; and a liquid-regeneration unit configured to remove a target gas from a target gas-rich fluid sorbent stream in the closed-loop liquid circuit. A method for selective desorption, including placing a sorbent loaded with a target gas in a sealed chamber; circulating a fluid sorbent stream through an eductor pump; adjusting a flow rate, a chemical formulation, or a temperature of the fluid sorbent; separating the desorbed target gas from fluid sorbent stream by an entrained-gas separator located downstream of the eductor pump; and regenerating the fluid sorbent stream.

### CROSS REFERENCE TO RELATED APPLICATIONS

This application claims the benefit of an earlier filing date from U.S. Provisional Application Serial No. 63/717,944 filed November 8, 2024, the entire disclosure of which is incorporated herein by reference.

### BACKGROUND

This disclosure is related to a system and a method for targeted gas desorption from sorbents via an eductor pump mechanism.

The field of gas separation and capture has seen growing interest in sorbent technologies for the removal of carbon dioxide and other target gases from dilute streams, including ambient air and industrial exhaust.

In direct air capture (DAC) applications, sorbents, while effective at capturing carbon dioxides, also co-adsorb water due to the strong affinity of water for the porous structure. This co-adsorption of water, while beneficial during the adsorption phase as it enhances the kinetics of carbon dioxide uptake, becomes problematic during the desorption phase. Specifically, water is often bound in a lower energy state than carbon dioxide, leading to the removal of water prior to carbon dioxide during regeneration. This premature removal of water results in a delay in the rehydration of the sorbent during subsequent adsorption cycles, thereby reducing the overall productivity and efficiency of the direct air capture system. Conventional approaches to sorbent regeneration fail to selectively desorb carbon dioxide while retaining water, leading to suboptimal energy usage and diminished system performance.

### SUMMARY

Disclosed herein is a system for regenerating a sorbent, including: a sealed chamber operative to receive the sorbent; a liquid circuit in fluid communication with the sealed chamber; an eductor pump disposed in the liquid circuit and having a motive-fluid nozzle, a diffuser, and a suction port in fluid communication with the sealed chamber, where a fluid sorbent stream is introduced into the eductor pump; an entrained-gas separator downstream of the eductor pump; and a liquid-regeneration unit configured to remove a target gas from a target gas-rich fluid sorbent stream in the closed-loop liquid circuit.

Also disclosed herein is a method for selective desorption. The method includes: placing a sorbent loaded with a target gas and at least one non-target vapor in a sealed chamber; circulating a fluid sorbent stream through an eductor pump into the sealed chamber such that the eductor pump creates a target pressure in the sealed chamber; adjusting a flow rate of the fluid sorbent stream to control an absolute pressure within the sealed chamber; adjusting at least one of a chemical formulation or a temperature of the fluid sorbent stream to establish a partial pressure within the sealed chamber that is lower for the target gas than for the at least one non-target vapor, thereby preferentially desorbing the target gas from the sorbent; and separating the desorbed target gas from fluid sorbent stream by an entrained-gas separator located downstream of the eductor pump. The method further includes regenerating the fluid sorbent stream by removing the target gas therefrom by a regeneration unit located downstream of the entrained-gas separator and returning the regenerated fluid sorbent stream to a pump located downstream of the regeneration unit and upstream of the eductor pump.

### BRIEF DESCRIPTION OF THE DRAWINGS

The following descriptions should not be considered limiting in any way. With reference to the accompanying drawings, like elements are numbered alike:

FIG. 1 is a schematic illustration of a selective desorption system;

FIG. 2 is a sectional detail of an eductor pump;

FIG. 3 is a control diagram illustrating the changes of absolute and partial pressures in an empty sealed chamber depending on chemical formulation and temperature;

FIG. 4 illustrates how fluid sorbent with varying chemistries and temperatures shifts the equilibrium of the system based on Le Chatelier’s principal;

FIG. 5 shows how the fluid sorbent with varying temperatures shifts the equilibrium of the system based on Le Chatelier’s principal;

FIG. 6 describes an experimental setup conducted in accordance with the present disclosures; and

FIG. 7 illustrates experimental data obtained using the aforementioned experimental setup.

### DETAILED DESCRIPTION

A detailed description of one or more embodiments of the disclosed system and method are presented herein by way of exemplification and not limitation with reference to the Figures.

Disclosed herein is a system that selectively regenerates sorbents by circulating a fluid sorbent stream through an eductor pump. The sorbent comprises some components that are similar in composition with the components in the fluid sorbent stream and by controlling the temperature of the sorbents as well as the temperature and flow rate of the fluid sorbent stream, the rate of desorption of the components from the sorbents can be varied.

The system includes a sealed chamber holding a sorbent, an eductor pump for vacuum generation in the sealed chamber, an optional entrained gas separator for separation of impurities and mechanically entrained gases, a regeneration unit for reconditioning the fluid sorbent stream, and a pump for fluid circulation.

The system operates on the principle of tailoring the absolute and partial pressure in the sealed chamber to selectively desorb a target gas (e.g., carbon dioxide) from a sorbent. The system operates on Le Chatelier’s principle which states that if a system at equilibrium is disturbed (by changing concentration, pressure/volume, or temperature), it shifts in the direction that reduces that disturbance until a new equilibrium is reached. An equilibrium is achieved through the chemical formulation, temperature, and flow rate of the fluid sorbent stream, which are manipulated to create a strong driving force for the target gas desorption while maintaining a weak driving force for water or amine desorption.

The rate of flow of the fluid sorbent stream through the eductor pump controls the absolute pressure (i.e., total pressure) within the chamber while also controlling (along with temperature of the fluid sorbent stream) the partial pressures of the gases and vapors in equilibrium with the gases and vapors that are coordinated with the sorbent. The fluid sorbent stream’s chemical formulation, temperature, and flow rate may therefore be adjusted to manage absolute and partial pressures in the system, enabling selective desorption of target gases while retaining beneficial co-adsorbed species.

By employing a closed-loop system, the fluid sorbent stream is continuously reconditioned to remove the desorbed target gas and is then recirculated to maintain the desired equilibrium conditions. This selective regeneration approach not only enhances the productivity of the direct air capture system by preserving the water content in the sorbent but also reduces the energy intensity of the process, offering an improvement over other previously used methods. In an embodiment, the system may also employ an open-loop system in which a batch process takes place when liquid sorbents are used. Furthermore, the system's adaptability to different fluid chemistries and operating conditions makes the approach broadly applicable to various gas separation and purification technologies beyond the capture of carbon dioxide.

Disclosed herein too is a method for selective desorption of target gases or vapors from a sorbent. The method includes placing a sorbent with a target gas adsorbed therein in a sealed chamber. A fluid sorbent stream that can absorb the target gas is circulated through an eductor pump. The eductor pump circulates the fluid sorbent stream through an eductor pump in a closed-loop circuit (also called a recycle loop) to set a controlled pressure in the sealed chamber. The headspace facilitates the removal of gases that are coordinated onto the sorbent. However, by changing partial pressures in the sealed chamber (via varying the concentration, pressure and temperature of the fluids in the fluid sorbent stream), the desorption rate of some of the coordinated gases may be reduced, while that of the others may be expedited, thereby preferentially removing some adsorbents from the sorbent.

The target gas that leaves the sorbent and dissolves in the fluid sorbent stream is removed from the fluid sorbent stream during a regeneration step. By recirculating the fluid sorbent stream through the closed loop, all of the adsorbed gas in the sorbent may be removed and stored separately. The sorbent (now devoid of the target gas) may then be replaced and the process started over with another batch of sorbent.

The use of the eductor pump to create a vacuum in the sealed space facilitates the desorbing of the target gas from the sorbent while reducing any degradation of functional molecules that are disposed on the sorbent to adsorb the target gas.

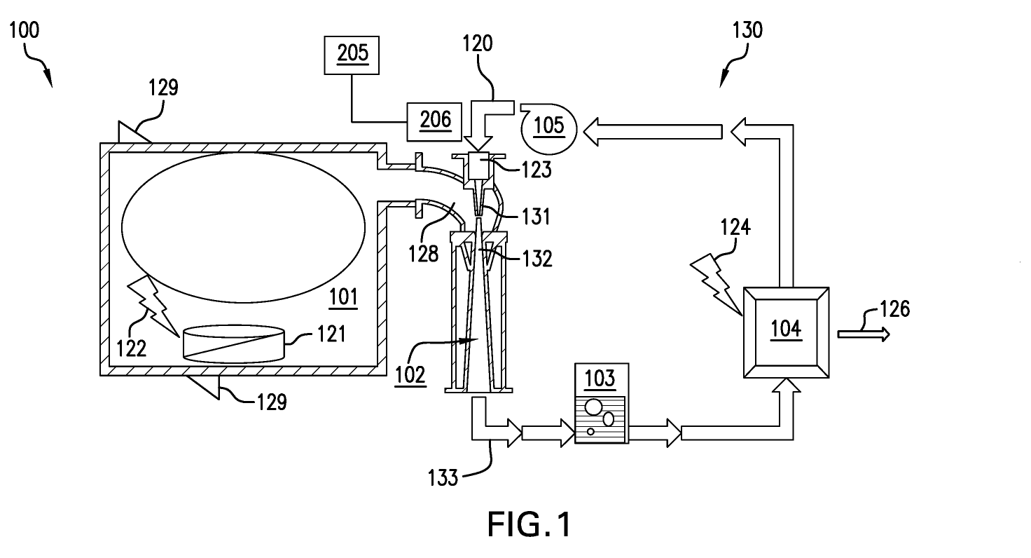

FIG. 1 is a schematic illustration of an embodiment of a system 100 for selective desorption. In system 100, a sealed chamber 101 is in fluid communication with a closed loop 130 which includes an eductor pump 102, an entrained gas separator 103, a regeneration unit 104, and a pump 105. The sealed chamber 101 may be an enclosed, fixed volume airtight space that isolates and contains a substance (e.g., a sorbent 121) in the sealed chamber 101. The sealed chamber 101 may be a part of an adsorption/desorption system that can be independently or dependently (e.g. through a transportation system) connected to the adsorption system or intermediary devices of the adsorption/desorption system In an embodiment, the pressure and temperature in the sealed chamber 101 may be varied to control the rate of desorption of gases and vapors that are coordinated with the sorbent 121. While the system 100 is described herein as being operative to regenerating solid sorbents, it may also be used in conjunction with liquid sorbents, or a combination of sorbents and liquid solvents. Henceforth, the term “sorbent” will imply sorbents in the solid state, the liquid state, or a combination comprising at least one of the foregoing states. In an embodiment, when the sorbent 121 is a metal-organic framework, the gases that are coordinated with it are an amine, water, and carbon dioxide. Other functional groups (other than amines) may be coordinated with a sorbent 121 for adsorbing gases other than carbon dioxide (e.g., nitrogen, nitrogen oxides, sulfur dioxides, and the like). It is to be noted that the sealed chamber 101 may be provided with inlet and outlet doors that can be hermetically sealed, agitators for agitating the sorbent contained therein, a heater, a vacuum pump, and other accessories that are used in chemical reactors.

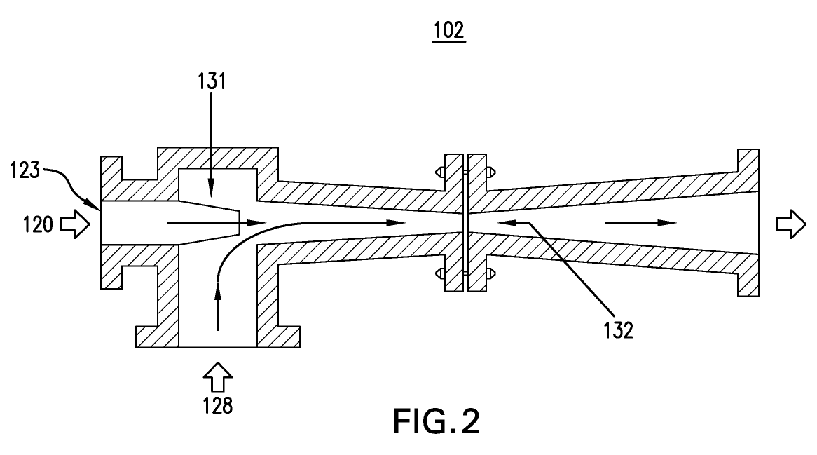

FIG. 2 depicts the eductor pump 102 disposed in the liquid circuit and having a motive-fluid nozzle (hereinafter nozzle), a converging–diverging section (a diffuser), and a suction port in fluid communication with the sealed chamber. Eductor pumps are sometimes known as Venturi eductors. Referring to FIGS. 1 and 2, the eductor pump 102 is a fluid handling device that uses the Venturi effect to move a suction fluid stream 128 from the sealed chamber 101 by forcing the fluid sorbent stream 120 (i.e., motive fluid) though a nozzle - 131, creating a low-pressure zone that is between the eductor pump 102 and the sealed chamber 101 that draws in and entrains the suction fluid stream 128. The eductor pump 102 is located downstream of the sealed chamber 101 and is in fluid communication with the sealed chamber 101. The eductor pump 102 controls the equilibrium conditions within the sealed chamber 101. The eductor pump 102 may have an inlet 123 where the high-pressure fluid sorbent stream 120 enters and is accelerated through the nozzle 131. A target gas-rich fluid sorbent stream 133, which is a mixture of the suction fluid stream 128 and the fluid sorbent stream 120, exits through a diffuser 132 (where mixing between the fluid sorbent stream 120 and the suction fluid stream 128 occurs and the target gas-rich fluid sorbent stream 133 is created), where velocity decreases and pressure increases. The diffuser promotes mixing between components that are desorbed from the sorbent 121 and the fluid sorbent stream 120.

The fluid sorbent stream 120 and the target gas-rich fluid sorbent stream 133 circulate in a closed loop 130 that includes the eductor pump 102, the entrained gas separator 103 located downstream of the eductor pump 102, the regeneration unit 104 located downstream of the entrained gas separator 103, and the pump 105 located downstream of the regeneration unit 104 and upstream of the eductor pump 102. It is to be noted that the eductor pump 102, the entrained gas separator 103, the regeneration unit 104 and the pump 105 lie in a recycle loop. The recycle loop may be a closed loop. In other words, the eductor pump 102, the entrained gas separator 103, the regeneration unit 104 and the pump 105 simultaneously lie upstream and downstream of one-another. The following description of the eductor pump 102, the entrained gas separator 103, the regeneration unit 104 and the pump 105 detail one cycle of the movement of the fluid sorbent stream 120 and the target gas-rich fluid sorbent stream 133 as they travel from the eductor pump 102 through the recycle loop and back to the eductor pump 102.

Downstream of the eductor pump 102 is an entrained gas separator 103 that is in fluid communication with the eductor pump 102. Located downstream of the eductor pump 102, the entrained-gas separator 103 is configured to separate non-chemisorbed gases from target gas-rich fluid sorbent stream 133. The entrained-gas separator 103 is designed to facilitate the removal of certain gases from the target gas-rich fluid sorbent stream 133 through physical and/or chemical separation mechanisms. Physical separation may be achieved through methods such as centrifugal force, gravitational settling, or phase disengagement, enabling the release and removal of entrained gases—such as air or inert carrier gases—from the liquid phase. In addition or alternatively, the entrained-gas separator 103 may incorporate chemical separation processes, such as selective absorption, adsorption, or reactive stripping, to capture and isolate trace gas species that may not be fully removed by physical means alone. By combining these separation modalities, the entrained gas separator 103 improves the purity and performance of the target gas-rich fluid sorbent stream 133, reduces the risk of cavitation or flow disruption in downstream components, and ensures more efficient operation of subsequent chemical absorption or regeneration stages.

The regeneration unit 104 is located downstream of the entrained-gas separator 103 in the closed loop 130 to remove carbon dioxide chemisorbed in the target gas-rich fluid sorbent stream 133 and return the regenerated fluid sorbent stream 120 to the pump 105. The regeneration unit 104 facilitates the desorption of the carbon dioxide from the target gas-rich fluid sorbent stream 133 through thermal, pressure-swing, or chemical regeneration methods. Within the regeneration unit 104, the target gas-rich fluid sorbent stream 133 is subjected to controlled conditions—such as elevated temperature, reduced pressure, or exposure to a stripping gas. - that reverses the chemisorption or physisorption process and releases the captured carbon dioxide as a concentrated gas stream (i.e., a purified gas stream 126) for subsequent handling or storage. The regenerated fluid sorbent stream 120, now substantially free of carbon dioxide, is then recirculated back and reintroduced into the pump 105 for continued use as the fluid sorbent stream 120. During the regeneration process, the purified gas stream 126 is discharged from the regeneration unit 104. This regeneration step maintains the cyclic operation of the system 100 and ensures the sustained efficiency and capacity of the fluid sorbent stream 120 over multiple cycles.

Located downstream of the regeneration unit 104 and upstream of the eductor pump 102, the pump 105 recirculates the regenerated fluid sorbent stream 120 back to the eductor pump 102. The pump 105 maintains adequate flow rate and pressure within the system 100 to ensure consistent delivery of the regenerated fluid sorbent stream 120 to the eductor pump 102 inlet, where it can be reintroduced into the sealed chamber 101. The pump 105 may be selected and operated based on the physical and chemical properties of the fluid sorbent stream 120, such as viscosity, temperature, and corrosiveness, to ensure durability and operational reliability over extended periods.

In an embodiment, the sealed chamber 101 has an opening or openings (e.g. a door 129 or a window) that facilitates the loading of the sorbent 121 into the sealed chamber 101. The opening has flexible seals installed around the edges that create an airtight seal and/or a locking mechanism to tightly close against the frame.

Detailed below are the materials that the system 100 operates upon and the method used in the system 100 to desorb a gas that is adsorbed in the sorbent 121. As noted above, the eductor pump 102 circulates fluid sorbent stream 120 through the eductor pump in a closed-loop recycle circuit to set an absolute pressure in the sealed chamber 101. The travel of the fluid sorbent stream 120 through the eductor pump creates a headspace of the sealed chamber 101, which facilitates the removal of a target gas desorbed from the sorbent 121. The target gas is removed from the fluid sorbent stream during a regeneration step.

### The solid state sorbent and liquid sorbent

The sorbent 121 adsorbs or absorbs gases, liquids that need to be regenerated. For example, it can contain carbon dioxide that needs to be sequestered to meet with environmental restrictions. The sorbent 121 may be a solid porous material that undergoes chemical coordination with certain gases. Some of the gases that are coordinated with the sorbent 121 are functional molecules (e.g. amines) that further facilitate adsorbing other gases from an exhaust gaseous stream, from a vent or from direct air capture. The solid adsorbent 121 may be capable of adsorbing and desorbing a variety of different fluids. The fluids as disclosed herein may include liquids and/or gases. Examples of suitable gases include carbon dioxide, nitrogen, sulfur dioxide, nitrogen dioxide, or the like, or a combination thereof. An exemplary gas that may be adsorbed by the sorbent 121 includes carbon dioxide. The extraction of excess carbon dioxide from the atmosphere is desired for environmental reasons and the system disclosed herein can efficaciously remove carbon dioxide from a fluid sorbent stream 120.

Representative solid sorbents include metal organic frameworks (MOFs), activated carbons, aluminophosphates, conjugated microporous polymers (CMP), covalent-organic frameworks (COFs), crystalline open frameworks, crystalline porous materials, hyper crossed-linked polymer (HCP), metal-organic materials (MOM), microporous polymer network (MPN), organic molecular solids, polyaromatic frameworks (PAFs), polymer with intrinsic microporosity (PIM), porous aromatic framework (PAF), porous coordination networks (PCN), porous coordination polymers (PCPs), porous organic polymer (POP), porous polymer network (PPN), silica particles, silico-alumino-phosphates (SAPOs), zeolites, zeolitic imidazolate frameworks (ZIFs), metal oxides, ion exchange resins, amine-appended polymers or the like, or a combination thereof.

In an embodiment, the sorbent 121 includes a metal organic framework (MOF). As disclosed herein, metal-organic frameworks are a class of compounds including a metal ion or a metal cluster coordinated with an organic linker to form one-, two-, or three-dimensional structures. The metal ions or metal clusters act as joints and are bound by multidirectional organic linkers. The metal-organic frameworks of the present disclosure include metal-organic frameworks with a plurality of metal, metal oxide, metal cluster, or metal oxide cluster building units.

In some embodiments, suitable metal ions or clusters include metals and metalloids of varying coordination geometries and oxidation states. In some embodiments, the metal ions or clusters are selected from transition metals, alkali metals, alkaline earth metals, calcium (Ca), cadmium (Cd), cobalt (Co), chromium (Cr), magnesium (Mg), manganese (Mn), iron (Fe), nickel (Ni), copper (Cu), ruthenium (Ru), zinc (Zn), zirconium (Zr), ions thereof, hydrates thereof, salts thereof, halides thereof, fluorides thereof, chlorides thereof, bromides thereof, iodides thereof, nitrates thereof, acetates thereof, sulfates thereof, phosphates thereof, carbonates thereof, oxides thereof, formates thereof, carboxylates thereof, and combinations thereof. In some embodiments, preferred metal ions or clusters are magnesium (Mg), iron (Fe), zinc (Zn), zirconium (Zr), or a combination thereof.

In one embodiment, the metal ions or clusters are selected from the group consisting of aluminum (Al), antimony (I) (Sb), arsenic (I) (As), barium (Ba), beryllium (Be), bismuth (I) (Bi), bismuth (III) (Bi), bismuth (V) (Bi), cadmium (Cd), calcium (Ca), chromium (Cr), cobalt (II) (Co), cobalt (III) (Co), copper (I) (Cu), copper (II) (Cu), gallium (Ga), germanium (II) (Ge), germanium (IV) (Ge), gold (I) (Au), hafnium (Hf), indium (In), iridium (I) (Ir), iridium (II) (Ir), iron (II) (Fe), iron (III) (Fe), lithium (Li), magnesium (Mg), manganese (Mn), mercury (II) (Hg), molybdenum (Mo), nickel (II) (Ni), nickel (Ni), niobium (Nb), osmium (II) (Os), osmium (III) (Os), palladium (I) (Pd), palladium (II) (Pd), platinum (I) (Pt), platinum (II) (Pt), rhenium (II) (Re), rhenium (III) (Re), rhodium (I) (Rh), rhodium (II) (Rh), rubidium (Rb), ruthenium (II) (Ru), ruthenium (III) (Ru), scandium (Sc), silicon (II) (Si), silicon (IV) (Si), silver (Ag), sodium (Na), strontium (Sr), tantalum (Ta), thallium (III) (Tl), tin (II) (Sn), tin (IV) (Sn), titanium (Ti), tungsten (W), yttrium (Y), zinc (II) (Zn), zirconium (Zr), or a combination thereof.

The metal ions or clusters are connected by organic linkers to form a porous structure. In some embodiments, the organic linker is a linker selected from the group consisting of polytopic linkers, ditopic linkers, tritopic linkers, tetratopic linkers, pentatopic linkers, hexatopic linkers, heptatopic linkers, octatopic linkers, mixed linkers, desymmetrized linkers, metallo linkers, N-heterocyclic linkers, or a combination thereof.

In some embodiments, the organic linker is a linker selected from the group consisting of 1,3,5-benzenetribenzoate (BTB), 1,4-benzenedicarboxylic acid, 1,4-bis(carboxymethyl)piperazine-2,3-dicarboxylic acid, 1,4-bis-(phenylamino)benzene-2,5-dicarboxylic acid, 1,4-butanedicarboxylic acid, 1,4-cyclohexanedicarboxylic acid, 1,5-dioxide-2,6-naphthalenedicarboxylate (dondc), 1,6-hexanedicarboxylic acid, 1,7-heptanedicarboxylic acid, 1,8-heptadecanedicarboxylic acid, 1,8-naphthalenedicarboxylic acid, 1,9-heptadecanedicarboxylic acid, 2,2′-biquinoline-4,4′-dicarboxylic acid, 2,4-pyridinedicarboxylate, 2,5-dioxidobenzene-1,4-dicarboxylate (dobdc), 2,5-pyridinedicarboxylic acid, 2,6 naphthalene dicarboxylate, 2,6-naphthalene dicarboxylic acid, 2-hydroxy-l,2,3-propanetricarboxylic acid, 2-isopropylimidazole-4,5-dicarboxylic acid, 2-methylimidazole-4,5-dicarboxylic acid, 2-methylquinoline-3,4-dicarboxylic acid, 2-nitrobenzene-l,4-dicarboxylic acid, 4,4′- diaminophenylmethane-3,3′-dicarboxylic acid, 4,4′- dihydroxyazobenzene-3,3′-dicarboxylic acid, 4,4′- dihydroxydiphenylmethane-3,3′-dicarboxylic acid, 4,4′-diaminodiphenyl-3,3′-dicarboxylic acid, 4,4′-dioxidobiphenyl-3,3′-dicarboxylate (dobpdc), 4,4'-dioxido-3,3'-biphenyldicarboxylate, 4,4'-dioxido-3,3'-triphenyldicarboxyl (dotpdc), 4,5-imidazoledicarboxylic acid, 4,6-dihydroxyisophthalic acid, 4-aminophenyl-1H-tetrazole, 4-cyclohexene-1,2-dicarboxylic acid, 4-oxopyran-2,6-dicarboxylic acid, 5,5-dioxodibenzothiophene-3,7-dicarboxylic acid, 5,6-dehydronorbomane-2.3-dicarboxylic acid, 5,6-dimethyl-2,3-pyrazinedicarboxylic acid, 5-ethyl-2,3-pyridinedicarboxylic acid, 5-hydroxy-1,3-benzenedicarboxylic acid, 5-t-butyl-1,3-benzenedicarboxylic acid, 6-chloroquinoxaline-2,3-dicarboxylic acid, 6-pyridinedi carboxy lie acid, 7,8-quinolinecarboxylic acid, 7-chloro-2,3,8-quinolinetricarboxylic acid, 7-chloro-3-methylquinoline-6,8-dicarboxylic acid, 7-chloro-4-hydroxyquinoline-2,8-dicarboxylic acid, 7-chloro-8-methylquinoline-2,3-dicarboxylic acid, 7-chloroquinoline-3,8-dicarboxylic acid, 8-tetracarboxy lie acid, 8-methoxy-2,3-naphthalenedicarboxylic acid, 8-nitro-2,3-naphthalenedicarboxylic acid, 8-sulfo-2,3-naphthalenedicarboxylic acid, acetylene dicarboxylate, acetylenedicarboxylic acid, adamantanedicarboxylic acid, adamantanetetracarboxylate, adamantanetribenzoate, anthracene-2,3- dicarboxylic acid, anthraquinone-1,5- dicarboxylic acid, aurinetricarboxylic acid, benzene dicarboxylate, benzenedicarboxylic acid, benzenetetracarboxylic acid, benzenetribenzoate, benzenetricarboxylate, benzenetricarboxylic acid, benzidine-3,3′-dicarboxylic acid, benzophenonetetracarboxylic acid, biphenyl dicarboxylate, biphenyl-4,4′-dicarboxylate, butanetetracarboxylic acid, butanetricarboxylic acid, cyclobutane-1,1-dicarboxylic acid, cyclobutyl dodecyl terephthalate, cyclohexene-2,3-dicarboxylic acid, cyclopentane-l,2,3,4-tetracarboxylic acid, cyclopentanetetracarboxylic acids, decanedicarboxylic acid, dicarboxylic acid, diimidedicarboxylic acid, dioxaoctanedicarboxylic acid, dioxybiphenyl-2,2'-dicarboxylate, diphenylether-4,4′-dicarboxylic acid, eicosenedicarboxylic acid, furan-2,5-dicarboxylic acid, heptadecanedicarboxylic acid, hexanetetracarboxylic acid, hexatriacontanedicarboxylic acid, imidazole-2,4-dicarboxylic acid, imidazole-4,5-dicarboxylic acid, l-benzyl-lH-pyrrole-3,4-dicarboxylic acid, l-methylpyrrole-3,4- dicarboxylic acid, naphtalenedicarboxylate, naphthalene-1,8-dicarboxylic acid, naphthalenedicarboxylic acid, o-hydroxybenzophenonedicarboxylic acid, octanedicarboxylic acid, octanetetracarboxylic acid, p-benzenedicarboxylic acid, pentane-3,3-carboxylic acid, perylene-3.4.9,10-tetracarboxylic acid, perylene-3,9-dicarboxylic acid, perylenedicarboxylic acid, perylene-l,12-sulfone-3,4,9,10-tetracarboxylic acid, perylenetetracarboxylic acids, phenylindanedicarboxylic acid, propanetricarboxylic acid, pyrazine-2,3-dicarboxylic acid, pyrazinedicarboxylic acid, pyrazole-3,4-dicarboxylic acid, pyrazoledicarboxylic acid, pyrene 2,7-dicarboxylate, pyridine-2,3-dicarboxylic acid, pyridine-2,6-dicarboxylic acid, pyridine-3,4-dicarboxylic acid, pyridinedicarboxylic acid, quinoline-2,4-dicarboxylic acid, quinoline-3,4-dicarboxylic acid, quinoxaline-2,3-dicarboxylic acid, terephthalic acid, terphenyl dicarboxylate, tetradecanedicarboxylic acid, tetrahydrofurantetracarboxylic acid, tetrahydropyran-4,4-dicarboxylic acid, tetrahydropyrene 2,7-dicarboxylate (HPDC), tetrazolates, thiophene-3,4-dicarboxylic acid, tricarboxylates, trioxaundecanedicarboxylic acid, 1H,5H-benzo(1,2-d:4,5-d′)bistriazole) (BBTA), 1H,7H-[1,4]dioxino[2,3-F:5,6-F']bisbenzotriazole (BTDD), 1H,1′H-5,5′-bibenzo[d][1,2,3]triazole (BIBTA) or a combination thereof.

In an embodiment, after the functionalization of the metal clusters with organic linker, functional moieties comprising amines may be added to the reactor to produce metal organic frameworks having amine functionalities. The functionalization is typically conducted in the reactor with the functional moieties being either in vapor or liquid forms. As used herein, the term “functional group” refers to a specific group of atoms within a molecule that imparts characteristic chemical reactivity and physical properties. Exemplary functional groups include, without limitation: hydroxyl groups (–OH), as found in alcohols and phenols; carbonyl groups (C=O), including aldehydes (–CHO) and ketones (–C(=O)–); carboxyl groups (–COOH), characteristic of carboxylic acids; ester groups (–COOR); amide groups (–CONH₂, –CONHR, –CONR₂); amino groups (–NH₂, –NHR, –NR₂); thiol groups (–SH); ether linkages (–O–); alkenes (–C=C–); alkynes (–C≡C–); nitriles (–C≡N); sulfonic acid groups (–SO₃H); sulfoxides (–S(=O)–); sulfones (–S(=O)₂–); halogens (–F, –Cl, –Br, –I); aryl groups (–Ar), such as phenyl; and acyl groups (–C(O)R). These functional groups may be incorporated independently or in combination into a compound to modulate its chemical, physical, or biological behavior.

In some embodiments, functional molecules refer to specific groups of atoms within molecules that are responsible for the characteristic chemical reactions of those molecules. Functionalization is a process that facilitates the attachment or bonding (e.g., covalent bonding, ionic bonding, hydrogen bonding, and so on) of functional molecules to a substrate (e.g., porous substrate) to obtain a functionalized substrate. Examples of functional group that can be used in this disclosure, include, but are not limited to, substituted or unsubstituted alkyls, substituted or unsubstituted alkenyls, substituted or unsubstituted alkynyls, substituted or unsubstituted aryls, substituted or unsubstituted hetero-alkyls, substituted or unsubstituted hetero-alkenyls, substituted or unsubstituted hetero-alkynyls, substituted or unsubstituted cycloalkyls, substituted or unsubstituted cycloalkenyls, substituted or unsubstituted hetero-aryls, substituted or unsubstituted heterocycles, dipole molecules, polar molecules, polar chemicals, halos, hydroxyls, anhydrides, carbonyls, carboxyls, carbonates, carboxylates, aldehydes, haloformyls, esters, hydroperoxy, peroxy, ethers, orthoesters, carboxamides, amines, imines, imides, azides, azos, cyanates, isocyanates, nitrates, nitriles, isonitriles, nitroso compounds, nitros, nitroso-oxy, pyridyls, sulfohydryls, sulfides, disulfides, sulfinyls, sulfos, thiocyanates, isothiocyanates, carbonothioyls, phosphinos, phosphonos, phosphates, and the like.

In some embodiments, the functional molecule comprises an amino group. The amino group may comprise a monoamine, diamine, triamine, tetra-amine, penta-amine, hexa-amine ligands, polyamine, alkylamine, and amino-alcohol. The amine can include primary amines, secondary amines, tertiary amines, or a mixture of at least one of those. The term “primary amines” is used herein to designate amines that have one single alkyl (or aryl or alkyl-aryl) substituent bonded to the nitrogen atom, while the rest of the substituents are hydrogen. The term “secondary amines” is used here to designate amines, which have two alkyl (or aryl) substituents bonded to the nitrogen atom, while one substituent is a hydrogen atom. The term “tertiary amines” is used herein to designate amines that have three alkyl (or aryl or alkyl-aryl) substituents bonded to the nitrogen atom, with no hydrogen atoms directly attached to the nitrogen.

Exemplary amines include 1,2-bis(3-aminopropylamino)ethane, 1,3-diaminopentane, 2,2-dimethyl-1,3-diaminopropane, 3-4 [N-(3-aminopropyl)-1,4-diaminobutane], bis(3-aminopropyl)amine, butylethylenediamine, di(N,N-dimethyl)ethylene diamine, di(N-methyl)ethylene diamine, diethanolamine, diethylenetriamine, diisopropanolamine (DIPA), ethylene diamine, iV-(2-aminoethyl)-1,3-propanediamine, l,2-bis(3-aminopropylamino)ethane, N-(2-aminoethyl)-1,3-propanediamine, N-(3-aminopropyl)-1,4-diaminobutane, N,N-diethylethylenediamine, N,N-diisopropylethylene diamine, N,N-dimethyl-N-methylethylene diamine, N,N′-bis(2-aminoethyl)-1,3-propanediamine, N,N′-bis(3-aminoethyl)-1,3-diaminoethane, N,N′-bis(3-aminoethyl)-1,3-diaminopropane, N,N′-bis(3-aminopropyl)-1,3-diaminoethane, N,N′-bis(3-aminopropyl)-1,3-diaminopropane, N,N′-bis(3-aminopropyl)-1,3-propanediamine, N,N′-bis(3-aminopropyl)-1,4-diaminobutane, N,N'-bis(3- aminopropyl)-l,3-propanediamine, N,N'-bis(3-aminopropyl)-1,4-diaminobutane, N,N-diethylethylenediamine, N,N-diisopropylethylene diamine, N,N-dimethylethylenediamine, N,N-dimethyl-N-methylethylene diamine, N,N-dimethylethylenediamine, N-ethylethylenediamine, N-isopropylethylenediamine, N-methylethylenediamine, polyethyleneamine, tetraethylenepentamine, triethylenetetramine, ethylenediamine, methyldiethanolamine (MDEA), monoethanolamine (MEA), polyethyleneimine (PEI), tetraethylenepentamine (TEPA), triethanolamine (TEA), triethylenediamine (TEDA), tris(2-aminoethyl) amine (TAEA), 2-(aminomethyl)piperidine, 1-(2-aminoethyl)piperidine, 4N, N´-bis(3-aminopropyl)-1,4-diaminobutane, N-pentylethane-1,2-diamineai, n-hexyl-ethylene-1,2-diamine, n-octyl- ethylene-1,2-diamine, N,N´-bis(2-aminoethyl)hexane-1,6-diamine, or a combination thereof.

In some embodiments, the disclosed metal-organic frameworks comprise a plurality of different types of metal ions or clusters, and/or a plurality of different types of organic linkers. In some embodiments, the disclosed metal-organic frameworks comprise organic linkers that are connected to two or more metal ions or clusters that comprise different metals, metal ions, or metal clusters.

In some embodiments, the disclosed metal-organic frameworks comprise metal ions or clusters that are connected by two or more types of different organic linkers, wherein the different types of organic linkers modify the chemical and physical properties of a metal-organic framework disclosed herein. The disclosed metal-organic frameworks are multivariate in that the material properties can be readily modified by changing the ratio between multiple types of metal ions or clusters or the type or ratio between multiple types of organic linkers.

In some embodiments, the metal-organic framework is selected from HKUST-1 (CAS ID: 222404-02-6), KAUST-7 (CAS ID: 1973399-07-3), MIL-100(Fe) (CAS ID: 1195763-37-1), MOF 5 (CAS ID: 255367-66-9); MOF-274, MOF-303, MOF-74, MOF-808, UiO-66 (CAS ID: 1072413-89-8), UiO-67, ZIF-7 (CAS ID: 909531-29-9), ZIF-8 (CAS ID: 59061-53-9), ZIF-90 (CAS ID: 1062147-37-8), M2(m-dobdc) (M = Mg, Mn, Fe, Co, Ni), and combinations thereof.

In some embodiments, the metal-organic framework comprises Mg2(dobpdc) (Mg₂(4,4′-dioxidobiphenyl-3,3′-dicarboxylate)).

In some embodiments, the surface area of the disclosed metal-organic frameworks can be at least 2 m²/g, or at least 20 m²/g, at least 200 m²/g, at least 500 m²/g, at least 600 m²/g, at least 700 m²/g, at least 800 m²/g, at least 850 m²/g, at least 900 m²/g, at least 950 m²/g, at least 1000 m²/g, at least 1050 m²/g, at least 1100 m²/g, at least 1150 m²/g, at least 1200 m²/g, at least 1250 m²/g, at least 1300 m ²/g, at least 1350 m²/g, at least 1400 m²/g, at least 1500 m²/g, at least 1800 m²/g, at least 2000 m²/g, or at least 3000 m²/g.

The sorbent may be in the form of loose particles, pellets, monoliths, cartridges, contactors, films. The sorbent may be present in any other known form used in an adsorption and/or desorption system.

In an embodiment, a sorbent may be in a liquid form. Examples of liquid sorbents at room temperature include the liquid sorbent composition comprises one or more compounds selected from the group consisting of alkanolamines, polyamines, amino acid salts, ionic liquids, carbonate- or bicarbonate-containing solvent blends, phase-change solvents, and amine-activated solvents. In certain embodiments, the alkanolamine may have the general formula HO–(CH₂)ₙ–N(R¹)(R²), where n is an integer from 1 to 4, and R¹ and R² are independently selected from hydrogen and C₁–C₆ alkyl groups. In other embodiments, the polyamine may have the formula NH₂–(CH₂)ₙ–NH–(CH₂)ₘ–NH₂, where n and m are integers independently ranging from 1 to 6. The amino acid salt may include compounds of the formula R–CH(NH–R³)–COO⁻M⁺, where R is a C₁–C₄ alkyl group, R³ is hydrogen or a C₁–C₄ alkyl group, and M⁺ represents a cation such as sodium, potassium, or an organic ammonium cation.

In certain embodiments, the sorbent comprises an ionic liquid having a cation C⁺ and an anion A⁻, wherein the anion is selected from carboxylate, alkylcarboxylate, amino-functionalized anions, or phosphonate anions, and wherein the ionic liquid is capable of reversibly binding carbon dioxide through chemisorption or physisorption. In further embodiments, the sorbent comprises carbonate or bicarbonate salts dissolved in one or more organic solvents, including but not limited to glycols, polyols, or high-boiling polar aprotic solvents. In other embodiments, the sorbent comprises a phase-change solvent that forms a carbon-dioxide-rich liquid phase and a carbon-dioxide-lean liquid phase under absorption and regeneration conditions, respectively. In yet other embodiments, the sorbent comprises an amine-activated solvent system in which a tertiary amine is combined with a promoter selected from piperazine, morpholine, cyclohexylamine, or other secondary or cyclic amines to enhance carbon-dioxide absorption kinetics and regeneration efficiency.

### The fluid sorbent stream

The fluid sorbent stream 120 comprises at least some components that are also present as sorbents in or on the solid sorbents. This enables a control of the rate of desorption of these components (from the sorbents 121 contained in the sealed chamber 101) by controlling the partial pressure these components in the sealed chamber. The partial pressures in the sealed chamber are controlled by controlling the composition, pressure and temperature of fluid sorbent stream.

In an embodiment, at least one component of the fluid sorbent stream is chemically identical to at least one component that is adsorbed on the sorbent 121. In another embodiment, at least two components of the fluid sorbent stream are chemically identical to at least two components that are adsorbed on the sorbent 121.

In an embodiment, the fluid sorbent stream 120 may comprise at a first solvent. The first solvent is similar to at least one solvent that is coordinated with the sorbent 121 present in the sealed chamber. Suitable solvents include water, propylene carbonate, ethylene carbonate, butyrolactone, acetonitrile, benzonitrile, nitromethane, nitrobenzene, sulfolane, dimethylformamide, N- methylpyrrolidone, methanol, acetonitrile, nitromethane, ethanol, propanol, isopropanol, butanol, benzene, toluene, methylene chloride, carbon tetrachloride, hexane, diethyl ether, tetrahydrofuran, or the like, or a combination thereof. An exemplary first solvent is water.

In another embodiment, the fluid sorbent stream comprises at least one functional group that is similar to a functional group that is coordinated on the sorbents 121 present in the sealed chamber 101. Functional groups are already detailed above and will not be detailed in the interests of brevity. An exemplary functional group comprises moieties that can coordinate with the target gases that the sorbent is designed to adsorb. One such target gas is carbon dioxide. An exemplary functional group comprises amines.

The ratio of the first solvent to the functional group in the fluid sorbent stream 120 may vary depending the amount of the component that it is desirable to remove from the sorbent present in the sealed chamber 101. The functional group in the fluid sorbent stream can be added during the process to maintain optimal concentration or pH. In an embodiment, the amount of the first solvent to the functional group may vary from 1:99 to 99:1, or 10:90 to 90:10, or 30:70 to 70:30, or 40:60 to 60:40.

### Method of manufacture

In one embodiment, in one manner of using the system, the method comprises affixing an eductor to a sealed chamber that contains a sorbent 121 loaded with a target gas. The chamber may be part of an adsorption and/or desorption system used to capture acid gases such as carbon dioxide, sulfur oxides, nitrogen oxides, hydrogen, carbon monoxide, nitrogen, methane, and the like. The chamber may be part of a continuous or batch adsorption and/or desorption process.

The eductor is then connected to an entrained gas separator, a regeneration unit, and a pump to form the system. A fluid sorbent stream is then charged closed loop. The pump is started to charge the fluid sorbent stream to the eductor which imposes a vacuum on the sealed chamber. The vacuum creates a head space in the sealed chamber, which then facilitates the desorption of the gases or vapors that are coordinated with the sorbent 121 present in the sealed chamber 101. By changing temperature or rate of flow of the fluid sorbent stream, the rate of desorption of the various components in the sorbent 121 may be changed. Targeted gases may be removed while others that are present in the sorbents 121 may be left behind in the sealed chamber. When the sorbent containing the target gas has reached equilibrium with the fluid sorbent stream, the sorbent from the sealed chamber 101 may be moved as loose particles, pellets or structures in batches (i.e. in moving-bed system) or liquids to the next station by a transportation system, such as but not limited to conveying systems, pumping system pipeline transport, fluidized bed transport.

In another embodiment, when all the targeted gases are removed, the contactor, cartridges, monolith, or stacked films may be moved to the next station by a crane or a robotic arm. In a third embodiment, the same configuration may be use for adsorption, by keeping opposite door opens, or desorption, by closing opposite doors to create vacuum within the chamber (i.e. sealed chamber).

### Method of use

The system may thus be used to facilitate the removal of at least one of the adsorbents from the sorbent 121 present in the sealed chamber 101 while maintaining as much of the other coordinated gases in the sorbent 121 (contained in the sealed chamber 101) as possible.

With reference now again to the FIG. 1, an external energy 122 may be applied to the sorbent 121 to increase the rate at which it reaches that equilibrium with the target gas. The external energy 122 may be applied in the form of heat or pressure changes. The most common method is thermal energy, where heating the sorbent increases the kinetic energy of the adsorbed molecules, reducing the binding forces between the gas and the sorbent surface (from the sorbent 121 present in the sealed chamber 101). This accelerates desorption, helping the system reach a new equilibrium more quickly. A volumetric, non-contact source heating, such as microwave, dielectric, radio-frequency, or induction energy, is desirable for best performance. Additionally, lowering the surrounding partial pressure of the target gas (e.g., using vacuum or an eductor pump) can also act as a driving force, pulling the gas from the sorbent 121 into the sealed chamber 101 atmosphere. These energy inputs—thermal and mechanical—do not change the final equilibrium position set by thermodynamics, but they significantly reduce the time needed to reach it, improving the efficiency of the system 100.

In an embodiment, an external energy 124 may also be applied to the fluid sorbent stream 120 after leaving the eductor pump 102 to regenerate the fluid sorbent stream 120.

In an embodiment, the system 100 may include one or more sensors 206 operatively coupled to a controller 205. The controller is operative to set a motive-flow rate through the eductor and to set at least one of a temperature or a composition of liquid at an interface section communicating with the sealed chamber. The motive-flow rate establishes an absolute pressure in the chamber and the temperature or composition establishes a headspace partial-pressure profile within the chamber that promotes desorption of the target gas from the sorbent 121 (present in the sealed chamber 101) while suppressing desorption of a second constituent. The sensors 206 are configured to monitor key parameters of the fluid sorbent stream 120 within the system 100, including but not limited to temperature, flow rate, absolute pressure, partial pressure, and chemical composition. The sensors 206 may be positioned at various locations throughout the system 100, including in proximity to the eductor pump 102 and within or adjacent to the sealed chamber 101, to enable real-time data acquisition and system diagnostics.

The controller 205 receives signals from the sensors 206 and is programmed to analyze the data to maintain optimal operating conditions, ensure process safety, and regulate system performance. In an embodiment, if the partial pressure of the fluid sorbent stream 120 deviates from predefined thresholds, the controller 205 may adjust the chemical composition of the fluid sorbent stream 120. If the absolute pressure of the fluid sorbent stream 120 deviates from predefined thresholds, the controller 205 may adjust the flow rate via the eductor pump 102 or trigger an alert to initiate corrective action. In an embodiment, the controller 205 maintains the absolute pressure between 5 kilopascals (kPa) and 99 kPa absolute. In an embodiment, the controller 205 maintains the partial pressure of carbon dioxide below 5 kPa while maintaining the partial pressure of amine below 10 kPa.

In an embodiment, the controller 205 may implement a feedback algorithm that continuously minimizes specific energy consumption per unit of the target gas desorbed. In an embodiment, the target setpoints correspond to desorbing at least 5 wt% of the target gas while retaining at least 60 wt% of the sorbed water. In an embodiment, the target setpoints correspond to desorbing at least 5% of the adsorbed target gas while retaining at least 10% of the sorbed water based on the total uptake capacity.

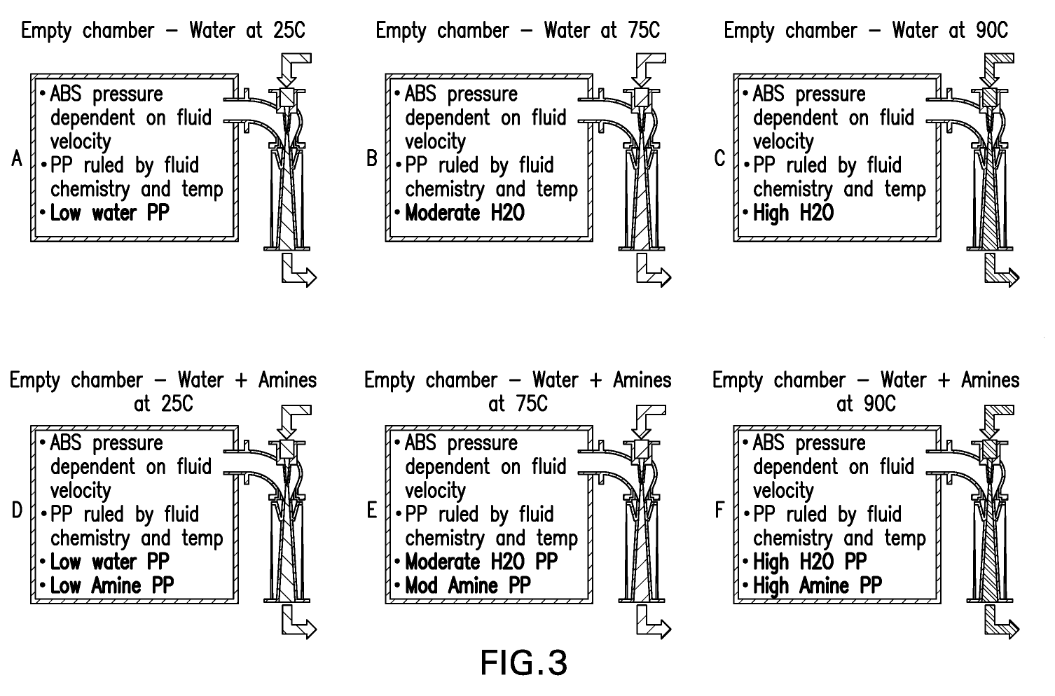

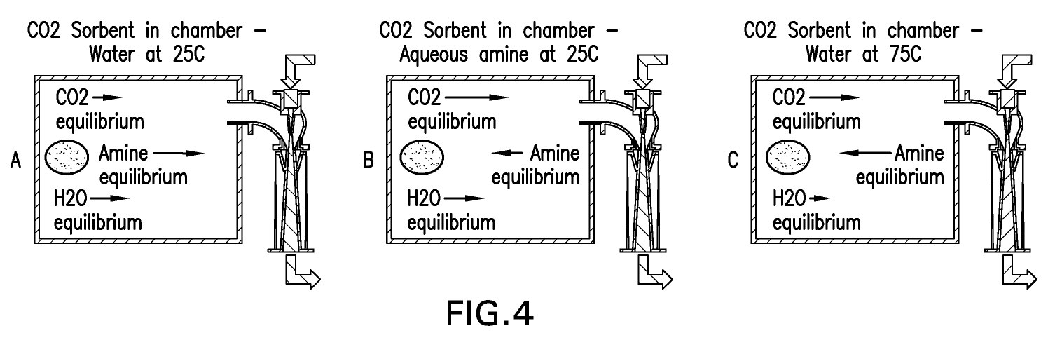

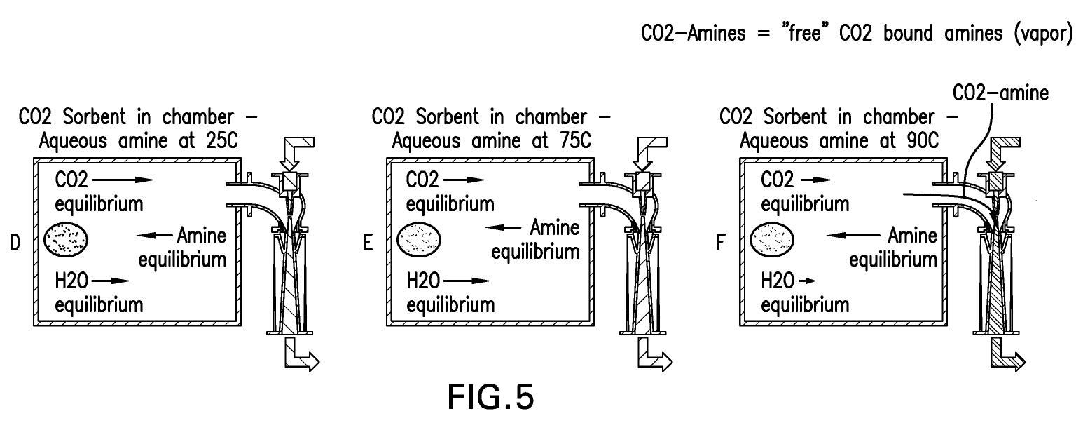

FIG. 3 illustrates the changes of absolute and partial pressures in the empty sealed chamber 101 depending on chemical formulation and temperature. Absolute pressure is dependent on the flow rate (i.e., velocity) of the fluid sorbent stream 120. Partial pressure is ruled by chemical formulation and temperature of the fluid sorbent stream 120. In case where the temperature of the fluid sorbent stream 120, including water, is 25℃, low water partial pressure is present. In case B where the temperature of the fluid sorbent stream 120 is 75℃, moderate water partial pressure is present. In case C where the temperature of the fluid sorbent stream 120 is 90℃, high water partial pressure is present. In case D where the temperature of the fluid sorbent stream 120, including water and amines, is 25℃, low water partial pressure and low amine partial pressure are present. In case E where the temperature of the fluid sorbent stream 120 is 75℃, moderate water partial pressure and moderate amine partial pressure are present. In case F where the temperature of the fluid sorbent stream 120 is 90℃, high water partial pressure and high amine pressure are present. Cases A, B and C are detailed in FIG. 4, while cases D, E and F are detailed in FIG. 5.

FIG. 4 illustrates how the fluid sorbent stream 120 with varying chemical formulation and temperatures shifts the equilibrium of the system 100 based on Le Chatelier’s principal. The sorbent 121 depicted in the sealed chamber 101 is also driven to reach equilibrium with the conditions present in the sealed chamber 101. In this manner, the fluid sorbent stream 120 can be tailored to selectively control the absolute and partial pressures in the chamber 101 thereby targeting the sorbent 121 for selective regeneration. The following cases are intended to illustrate the concept rather than reflect actual observations.

Cases A to C is a series of diagrams in which both the chemical formulation and the temperature of the fluid sorbent stream 120 are adjusted.

Case A: This scenario sets the baseline with water at 25 degrees Celsius (℃). In this particular case, there is a relatively low relative humidity and no amines present in the fluid sorbent stream. This generates a situation where both amines and water may be removed from the sorbent 121 at a relatively high rate. The carbon dioxide is also desorbed from the sorbent 121 at a rate that is driven by the fluid sorbent stream’s 120 affinity for the carbon dioxide. Carbon dioxide desorption primarily occurs through physical entrainment in the water, which is enhanced by the sorbent 121 heating. Low relative humidity within the sealed chamber 101 and heated sorbent 121 favors water desorption. No amine partial pressure induces amines desorption from heating the sorbent 121 inside the sealed chamber 101. At these conditions, water, carbon dioxide, and amines desorption occur.

Case B: In this case, the relative humidity is relatively low, and the partial pressure of amines is also low. Carbon dioxide desorption is caused by heated sorbent 121, and the affinity with the amines in the fluid sorbent stream 120. Low relative humidity within the chamber 101 favors water desorption due to the heating of the sorbent 121. The presence of amine partial pressure suppresses the amines desorption rate compared to case A. At these conditions, the desorption of water and amine removal is suppressed compared to case A, while the desorption of carbon dioxide is increased compared to case A.

Case C: Compared to case B, case C decreases in carbon dioxide gradient while suppressing the water and amine from leaving the sorbent. Relative humidity and amine partial pressure are higher due to the higher temperature of the fluid sorbent stream 120 and the heated sorbent 121. Carbon dioxide desorption is enhanced by heating the sorbent 121. However, the desorption equilibrium for carbon dioxide might not show much change compared to the situation at 25℃. Because the water is warmer, thus the affinity of carbon dioxide with amines may be lower. Higher temperature of the fluid sorbent stream 120 increases the relative humidity in the sealed chamber 101, i.e. higher water partial pressure, thus slowing down water desorption from the sorbent 121. Increasing amine partial pressure within the chamber 101 also slows down amine desorption. The fluid sorbent 120 stream temperature (75℃) is used to selectively desorb carbon dioxide and suppress water and amine desorption. A tailoring of the conditions for each species in the sorbent 121 is dependent on the temperature and chemistry of the fluid stream.

FIG. 5 illustrates how the fluid sorbent stream 120 with varying temperatures shifts the equilibrium of the system 100 based on Le Chatelier’s principal. Cases D to F are a series of diagrams in which temperature of the fluid sorbent stream 120 is adjusted.

Case D: In this case, there is the fluid sorbent stream 120 comprised of amines dissolved in water at 25 ℃. The carbon dioxide gradient is stronger toward water with amine in comparison to just water as the carbon dioxide has a high affinity for the amines. The water equilibrium arrow is longer in comparison to the higher temperature cases but equal when comparing to the same temperature case. The amine equilibrium arrow is short to show the amine partial pressure is low with the cooler temperature of the fluid sorbent stream 120 therefore more amines will leave the sorbent 121. In this case, low relative humidity is low, and amine partial pressure is also low. Carbon dioxide desorption is favored by the affinity with amine in the fluid sorbent stream 120 and is enhanced by heating the sorbent 121. Low relative humidity (low water partial pressure) within the chamber 101, favors water desorption, and the sorbent 121 heating increases the rate of desorption. Low amine partial pressure induces amines desorption that is enhanced by sorbent heating 121. At these conditions, there is a favorable desorption mechanism of water and carbon dioxide but amine desorption is less favorable than Case A.

Case E: This case shows the same chemistry at a higher temperature of 75 ℃. At this temperature, the carbon dioxide gradient is shortened slightly as there is only a minor change to the binding affinity of the carbon dioxide to the liquid amine stream. The higher temperature also increases the relative humidity in the chamber 101 increasing the water partial pressure, weakening the gradient to the water in the sorbent 121. The amine arrow increases length because the amine partial pressure also increases with the temperature of the fluid sorbent stream 120. This increased partial pressure slows the amine release from the sorbent 121. In comparison to the 25 ℃, in this case, the fluid sorbent stream 120 temperature is now used to selectively desorb carbon dioxide and suppress the release of water and amine. There is higher relative humidity and higher amine partial pressure due to the higher temperature of the fluid sorbent stream 120. Cabon dioxide desorption is enhanced by heating sorbent 121. However, the system 101 may not have significant changes in desorption equilibrium compared to the 25 ℃ scenario, as the warmer water may reduce the affinity of carbon dioxide with amines. Higher temperature of the fluid sorbent stream 120 increases the relative humidity in the chamber 101, i.e. higher water partial pressure, thus slowing down water desorption from the sorbent 121 (i.e. water saturation). Increasing amine partial pressure within the chamber 101 also slows down amine’s desorption. The fluid stream temperature (75 ℃) is used to selectively desorb carbon dioxide and suppress water and amine desorption.

Case F: In the 90 ℃ case, the carbon dioxide arrow shortens further due to the liquid amine ability to bind carbon dioxide at 90 ℃. As the stream is continuously regenerated to accept carbon dioxide bound to amines, it creates a gradient for the carbon dioxide to be removed from the sorbent. In the case of the amines and the water, increasing the temperature further increases the water and amine partial pressure. This slows the removal of water and amine from the sorbent 121 even further. In this case, there is the highest relative humidity and amine partial pressure compared to previous cases. As the carbon dioxide desorption is driven by its affinity with the amines in the fluid sorbent stream 120, the temperature increase may have some impact on carbon dioxide desorption. Higher relative humidity prevents water desorption. The increase in amine partial pressure within the chamber 101 decreases amine desorption. The fluid sorbent stream 120 temperature (90 ℃) is used to favor carbon dioxide desorption over water and amine removal.

The following section describes experiments conducted in accordance with the present disclosures and the results obtained therefrom.

### Experimental Setup

A series of experiments were conducted to evaluate the desorption and capture performance of a hybrid CO₂ sorbent system comprising a solid amine-functionalized polymer (the solid sorbent) and a liquid sorbent stream.

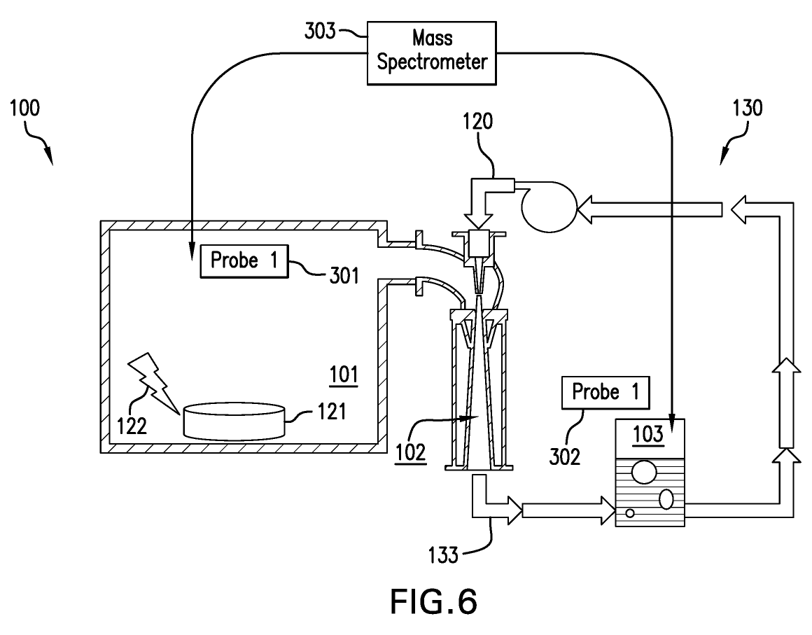

Referring to FIG. 6, the experimental setup includes a closed chamber 101 containing a solid sorbent 121 material (Lewatit® amine-modified polymer) in fluid communication with a liquid sorbent circuit. The chamber was equipped with a non-contact heating source 122 (microwave) to selectively heat the solid sorbent and induce carbon dioxide desorption. The system further included an eductor pump 102 connected to a pressure-generating pump, with the pump speed regulated by a variac to control the fluid flow rate. An entrained gas separator 103 was positioned downstream of the eductor pump 102 to separate gas from the circulating liquid stream. A closed fluid circuit 130 interconnected the above components.

In addition, a mass spectrometer 303 was employed to continuously measure the partial pressure of carbon dioxide at two distinct locations within the system:

Probe 1 (301): located in the gas space of the closed chamber containing the solid sorbent, and

Probe 2 (302): located in the gas space of the entrained gas separator.

### Experimental Procedure

Two experiments were performed under identical operating conditions, differing only in the composition of the liquid sorbent stream:

Experiment 1: Deionized water is used as the liquid sorbent.

Experiment 2: Aqueous sodium hydroxide solution is used as the liquid sorbent.

The solid sorbent bed was initially saturated with carbon dioxide under controlled conditions. The non-contact microwave heating source was then activated to increase the sorbent temperature to the threshold desired for carbon dioxide release. The evolution of carbon dioxide was monitored in real time via the mass spectrometer.

### Results and Observations

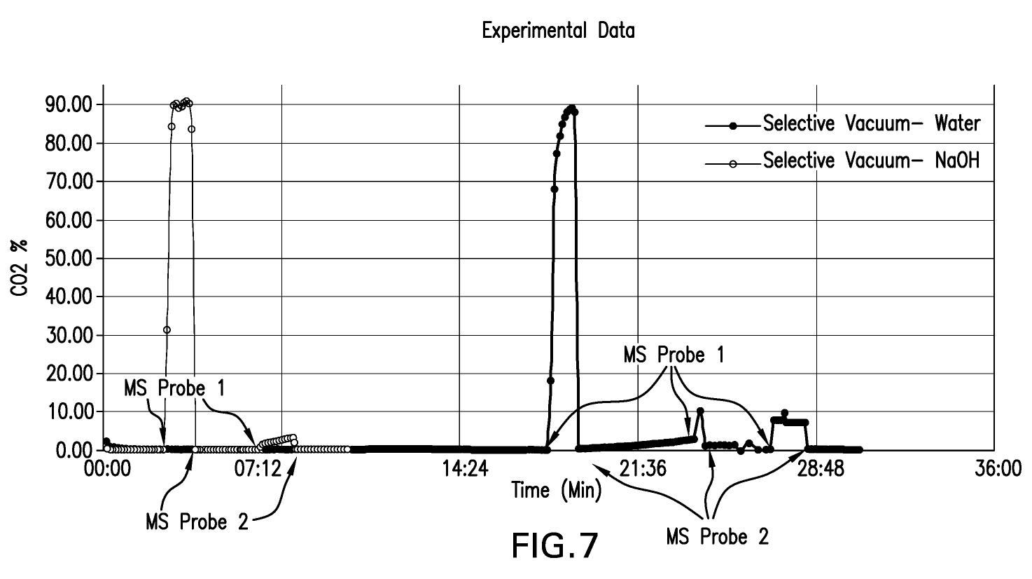

Referring to FIG. 7, in both experiments, Probe 1 detected an initial sharp rise in carbon dioxide partial pressure, corresponding to the onset of desorption as the solid sorbent reached the target temperature. This confirmed the release of carbon dioxide from the amine-functionalized polymer matrix.

Subsequent measurements from Probe 2 reflected the transfer of carbon dioxide through the liquid circuit into the entrained gas separator.

In the water-based system, the carbon dioxide partial pressure at Probe 2 increased progressively, indicating mechanical entrainment of desorbed carbon dioxide into the gas phase above the separator.

In contrast, in the aqueous sodium hydroxide-based system, the carbon dioxide partial pressure at Probe 2 remained very low, demonstrating that carbon dioxide released from the solid sorbent was chemically absorbed by the aqueous sodium hydroxide solution and retained in the liquid phase.

When the monitoring was switched back to Probe 1, a marked difference was observed between the two systems. The aqueous sodium hydroxide -containing liquid maintained a lower carbon dioxide partial pressure in the chamber, confirming that the aqueous sodium hydroxide solution exhibited a higher affinity for carbon dioxide compared with its affinity for pure water. The water-only system showed correspondingly higher gas-phase carbon dioxide concentration.

The experimental results demonstrate that the use of a reactive liquid sorbent (aqueous sodium hydroxide solution) in conjunction with a solid amine sorbent significantly reduces the carbon dioxide partial pressure in the gas phase and enhances the overall carbon dioxide capture capacity of the system. The configuration enables efficient cyclic adsorption and desorption through controlled heating and liquid phase circulation.

Set forth below are some embodiments of the foregoing disclosure:

Embodiment 1. A system for regenerating a sorbent, including: a sealed chamber operative to receive the sorbent; a liquid circuit in fluid communication with the sealed chamber; an eductor pump disposed in the liquid circuit and having a motive-fluid nozzle, a diffuser, and a suction port in fluid communication with the sealed chamber, where a fluid sorbent stream is introduced into the eductor pump; an entrained-gas separator downstream of the eductor pump; and a liquid-regeneration unit configured to remove a target gas from a target gas-rich fluid sorbent stream in the closed-loop liquid circuit.

Embodiment 2. The system as in any prior embedment, further including a controller operable to set a motive-flow rate through the eductor pump and to set at least one of a temperature or a composition of liquid at an interface section communicating with the sealed chamber, wherein the motive-flow rate establishes an absolute pressure in the sealed chamber and the temperature or composition establishes a headspace partial-pressure profile within the sealed chamber that promotes desorption of the target gas from the sorbent while suppressing desorption of a second constituent.

Embodiment 3. The system as in any prior embedment, wherein the sealed chamber includes a heater selected from resistive, radiant, convective, and microwave heaters, dielectric, induction.

Embodiment 4. The system as in any prior embedment, wherein the sorbent is selected from metal organic frameworks, aminosilicas, zeolites, polymeric sorbents, carbons, alumina, silica, layered double hydroxides, or the like, or a combination comprising at least one of the foregoing.

Embodiment 5. The system as in any prior embedment, wherein the fluid sorbent stream includes water, and at least one of an amine, a hydroxide, a carbonate or a combination comprising at least one of the foregoing.

Embodiment 6. The system as in any prior embedment, wherein the fluid sorbent stream includes an aqueous solution in a concentration between about 0.5 wt % and about 50 wt %.

Embodiment 7. The system as in any prior embedment, wherein the sorbent includes an aminated metal organic framework.

Embodiment 8. The system as in any prior embedment, wherein the sealed chamber contains the sorbent in a form selected from particulate beds, monoliths, coated monoliths, cartridges, or layered contactors.

Embodiment 9. The system as in any prior embedment, wherein a heat source operative to apply energy to the sorbent within the sealed chamber, comprises microwave, dielectric, radio-frequency, or induction energy.

Embodiment 10. The system as in any prior embedment, wherein the fluid sorbent stream has a chemical formulation and a

temperature selected to present a lower carbon dioxide partial pressure than exists in the sorbent.

Embodiment 11. The system as in any prior embedment, wherein the regeneration unit is a thermal stripper, a membrane contactor, or a flash separator adapted to release the target gas, comprising carbon dioxides, sulfur oxides, nitrogen oxides, or a combination comprising at least one of the foregoing, from the target gas-rich fluid sorbent stream.

Embodiment 12. The system as in any prior embedment, wherein the regeneration unit is configured to add an acid to the target gas-rich fluid sorbent stream to chemically release the target gas.

Embodiment 13. The system as in any prior embedment, wherein the system is part of a cyclic adsorption-desorption system.

Embodiment 14. The system as in any prior embedment, wherein the sealed chamber has at least one opening to introduce the sorbent loaded with the target gas.

Embodiment 15. A method for selective desorption, the method including: placing a sorbent loaded with a target gas and at least one non-target vapor in a sealed chamber; circulating a fluid sorbent stream through an eductor pump into the sealed chamber such that the eductor pump creates a target pressure in the sealed chamber; adjusting a flow rate of the fluid sorbent stream to control an absolute pressure within the sealed chamber; adjusting at least one of a chemical formulation or a temperature of the fluid sorbent stream to establish a partial pressure within the sealed chamber that is lower for the target gas than for the at least one non-target vapor, thereby preferentially desorbing the target gas from the sorbent; separating the desorbed target gas from fluid sorbent stream by an entrained-gas separator located downstream of the eductor pump; and regenerating the fluid sorbent stream by removing the target gas therefrom by a regeneration unit located downstream of the entrained-gas separator and returning the regenerated fluid sorbent stream to a pump located downstream of the regeneration unit and upstream of the eductor pump.

Embodiment 16. The method as in any prior embedment, further including supplying energy comprising microwave, dielectric, radio-frequency, or induction energy to the sorbent to accelerate desorption of the target gas.

Embodiment 17. The method as in any prior embedment, wherein the fluid sorbent stream includes water containing an amine dissolved therein.

Embodiment 18. The method as in any prior embedment, wherein the temperature of the fluid sorbent stream introduced while the eductor pump is operating is between about 25 °C and about 90 °C.

Embodiment 19. The method as in any prior embedment, wherein the sorbent retains at least 1 weight percent of the water originally present on the sorbent.

Embodiment 20. The method as in any prior embedment, wherein after the selective desorption process, the sorbent that has been removed with the target gas is transported to a next station that is a cooling device or an adsorption station to repeat an adsorption-desorption cycle.

The use of the terms “a” and “an” and “the” and similar referents in the context of describing the invention (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. The terms “about”, “substantially” and “generally” are intended to include the degree of error associated with measurement of the particular quantity based upon the equipment available at the time of filing the application. For example, “about” and/or “substantially” and/or “generally” includes a range of ± 8% of a given value.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited.

What is claimed is:

1. A system for regenerating a sorbent, comprising:
a sealed chamber operative to receive the sorbent;
a liquid circuit in fluid communication with the sealed chamber;
an eductor pump disposed in the liquid circuit and having a motive-fluid nozzle, a diffuser, and a suction port in fluid communication with the sealed chamber, where a fluid sorbent stream is introduced into the eductor pump;
an entrained-gas separator downstream of the eductor pump; and
a liquid-regeneration unit configured to remove a target gas from a target gas-rich fluid sorbent stream in the closed-loop liquid circuit.

2. The system of claim 1, further comprising a controller operable to set a motive-flow rate through the eductor pump and to set at least one of a temperature or a composition of liquid at an interface section communicating with the sealed chamber, wherein the motive-flow rate establishes an absolute pressure in the sealed chamber and the temperature or composition establishes a headspace partial-pressure profile within the sealed chamber that promotes desorption of the target gas from the sorbent while suppressing desorption of a second constituent.

3. The system of claim 1, wherein the sealed chamber comprises a heater selected from resistive, radiant, convective, and microwave heaters, dielectric, induction.

4. The system of claim 1, wherein the sorbent is selected from metal organic frameworks, aminosilicas, zeolites, polymeric sorbents, carbons, alumina, silica, layered double hydroxides, or the like, or a combination comprising at least one of the foregoing.

5. The system of claim 1, wherein the fluid sorbent stream comprises water, and at least one of an amine, a hydroxide, a carbonate or a combination comprising at least one of the foregoing.

6. The system of claim 5, wherein the fluid sorbent stream comprises an aqueous solution in a concentration between about 0.5 wt % and about 50 wt %.

7. The system of claim 1, wherein the sorbent comprises an aminated metal organic framework.

8. The system of claim 1, wherein the sealed chamber contains the sorbent in a form selected from particulate beds, monoliths, coated monoliths, cartridges, or layered contactors.

9. The system of claim 1, wherein a heat source operative to apply energy to the sorbent within the sealed chamber, comprises microwave, dielectric, radio-frequency, or induction energy.

10. The system of claim 1, wherein the fluid sorbent stream has a chemical formulation and a temperature selected to present a lower target gas partial pressure than exists in the sorbent.

11. The system of claim 1, wherein the regeneration unit is a thermal stripper, a membrane contactor, or a flash separator adapted to release the target gas, comprising carbon dioxides, sulfur oxides, nitrogen oxides, or a combination comprising at least one of the foregoing, from the target gas-rich fluid sorbent stream.

12. The system of claim 1, wherein the regeneration unit is configured to add an acid to the target gas-rich fluid sorbent stream to chemically release the target gas.

13. The system of claim 1, wherein the system is part of a cyclic adsorption-desorption system.

14. The system of claim 1, wherein the sealed chamber has at least one opening to introduce the sorbent loaded with the target gas.

15. A method for selective desorption, the method comprising:
placing a sorbent loaded with a target gas and at least one non-target vapor in a sealed chamber;
circulating a fluid sorbent stream through an eductor pump into the sealed chamber such that the eductor pump creates a target pressure in the sealed chamber;
adjusting a flow rate of the fluid sorbent stream to control an absolute pressure within the sealed chamber;
adjusting at least one of a chemical formulation or a temperature of the fluid sorbent stream to establish a partial pressure within the sealed chamber that is lower for the target gas than for the at least one non-target vapor, thereby preferentially desorbing the target gas from the sorbent;
separating the desorbed target gas from fluid sorbent stream by an entrained-gas separator located downstream of the eductor pump; and
regenerating the fluid sorbent stream by removing the target gas therefrom by a regeneration unit located downstream of the entrained-gas separator and returning the regenerated fluid sorbent stream to a pump located downstream of the regeneration unit and upstream of the eductor pump.

16. The method of claim 15, further comprising supplying energy comprising microwave, dielectric, radio-frequency, or induction energy to the sorbent to accelerate desorption of the target gas.

17. The method of claim 15, wherein the fluid sorbent stream comprises water containing an amine dissolved therein.

18. The method of claim 15, wherein the temperature of the fluid sorbent stream introduced while the eductor pump is operating is between about 25 °C and about 90 °C.

19. The method of claim 15, wherein the sorbent retains at least 1 weight percent of the water originally present on the sorbent.

20. The method of claim 15, wherein after the selective desorption process, the sorbent that has been removed with the target gas is transported to a next station that is a cooling device or an adsorption station to repeat an adsorption-desorption cycle.
